(19) United States
(12) Patent Application Publication
(10) Pub. No.: US 2014/0023898 A1
(43) Pub. Date: Jan. 23, 2014

(54) NON-AQUEOUS ELECTROLYTE SECONDARY CELL

(71) Applicants: Keisuke Minami, Kanzaki-gun (JP); Toyoki Fujihara, Kanzaki-gun (JP); Toshiyuki Nohma, Kobe-shi (JP)

(72) Inventors: Keisuke Minami, Kanzaki-gun (JP); Toyoki Fujihara, Kanzaki-gun (JP); Toshiyuki Nohma, Kobe-shi (JP)

(73) Assignee: SANYO ELECTRIC CO., LTD., Osaka (JP)

(21) Appl. No.: 13/550,974

(22) Filed: Jul. 17, 2012

(51) Int. Cl. H01M 10/36

(52) U.S. Cl. 429/94

(57) ABSTRACT

The present invention aims to productively provide a non-aqueous electrolyte secondary cell having excellent safety and high capacity. The above object can be achieved by adopting the following configuration. The non-aqueous electrolyte secondary cell comprises a wound electrode assembly formed by winding a positive electrode having a positive electrode active material layer, a negative electrode having a negative electrode active material layer and a separator separating the positive and negative electrodes, wherein: the filling density of the positive electrode active material layer is 2.0-2.8 g/cc; the filling density of the negative electrode active material layer is 1.0-1.5 g/cc; each thickness of the positive electrode and the negative electrode is 100-200 μm; the thickness of the separator is 10-30% of each thickness of the positive and negative electrodes; and the air permeability per unit thickness of the separator is 7.0-27.0 sec/100 cc•μm.

### BACKGROUND OF THE INVENTION

1. Field of the Invention

The present invention relates to a non-aqueous electrolyte secondary cell, and more specifically to a non-aqueous electrolyte secondary cell using a wound electrode assembly.

2. Background Art

Recently, there have become popular battery-powered vehicles such as electric vehicles (EV) and hybrid electric vehicles (HEV), which use a secondary battery as a drive power source. The battery-powered vehicles require a secondary cell with high output and high capacity. A non-aqueous electrolyte secondary cell typified by a lithium ion secondary cell has high energy density and high capacity. Moreover, because of its large facing area between the positive and negative electrode plates, it is easy to draw a large current from the electrode assembly formed by winding or laminating the positive and negative electrode plates comprising active material layers provided on both surfaces of an electrode core via a separator. For this reason, the non-aqueous electrolyte secondary cell having the spirally wound electrode assembly is used in the above applications.

Recently, in order to further enhance cell capacity, it is conducted to increase the amounts of the active material filled in the positive and negative electrodes. However, when performing a press in order to fill the active material in the electrode core at high density, there is a problem that the part of the electrode core, on which the active material is applied, extends and loosens to easily cause winding slippage. This problem tends to occur particularly in case of a high capacity cell with a long winding and in case of a cell having an electrode assembly with a variation in extension of the electrode core in the width direction (the direction perpendicular to the winding direction).

Since a separator, which is interposed and insulates between the positive and negative electrode plates, does not directly contribute to charging and discharging, a thick one leads to a decrease in energy density and power output. Meanwhile, a thin separator may degrade insulation reliability between the positive and negative electrode plates.

### SUMMARY OF THE INVENTION

The present invention is made in view of the above, and aims to productively provide a non-aqueous electrolyte secondary cell having high capacity, high energy density, high power output and excellent insulation reliability between the positive and negative electrode plates. The present invention relating to the prismatic cell for the purpose of solving the above problems has the following configuration.

A non-aqueous electrolyte secondary cell comprises a wound electrode assembly,

wherein:
the wound electrode assembly is formed by winding a positive electrode plate, a negative electrode plate and a separator separating the positive and negative electrode plates;
the positive electrode plate has a positive electrode core exposed portion, which is formed by exposing at least one side edge of a belt-shaped positive electrode core along the longitudinal direction of the positive electrode core, and a positive electrode active material layer formed on the positive electrode core;
the negative electrode plate has a negative electrode core exposed portion, which is formed by exposing at least one side edge of a belt-shaped negative electrode core along the longitudinal direction of the negative electrode core, and a negative electrode active material layer formed on the negative electrode core;
the filling density of the positive electrode active material layer is 2.0 to 2.8 g/cc;
the filling density of the negative electrode active material layer is 1.0 to 1.5 g/cc;
the thickness of the positive electrode plate is 100 to 200 μm;
the thickness of the negative electrode plate is 100 to 200 μm;
the thickness of the separator is 10 to 30% of each thickness of the positive and negative electrodes; and
the air permeability per unit thickness of the separator is 7.0 to 27.0 sec/100 cc•μm.

When rolling is performed on the positive or negative electrode plate in the above-described configuration in order to increase the filling density of the active material, pressure is applied to the active material layer-forming part of the electrode core to cause elongation of the core. On the other hand, since pressure of the rolling is not applied to the core exposed portion, elongation does not occur. Thereby, in the electrode plate in which at least one side edge of the belt-shaped core is exposed along the longitudinal direction of the core, variation in elongation of the core occurs in the width direction, and therefore winding slippage easily occurs during winding via a separator. In addition, it is difficult to wind the positive and negative electrodes having an excess thickness, while the positive and negative electrodes having a too thin thickness reduce the energy density because there is an increased percentage of the portion that does not contribute to charging and discharging, and its influence is also increased. For the purpose of increasing the energy density of the cell, it is preferable that the separator has smaller thickness. Moreover, for the purpose of increasing power output in case of an in-vehicle cell, it is preferable that the separator has smaller air permeability. However, if the thickness or air permeability of the separator is too small, it becomes more difficult to secure the insulation between the positive and negative electrode plates.

By controlling the thickness and filling density of the positive and negative electrode plates and the thickness and air permeability of the separator within the above-mentioned ranges, the insulation between the positive and negative electrodes is secured, winding slippage is prevented, and a non-aqueous electrolyte secondary cell having high energy density and high power output can be achieved.

In the above configuration, the positive electrode core may be made of pure aluminum or aluminum alloy while the negative electrode core may be made of pure copper or copper alloy.

The above materials are preferred as a core material because of low cost, low resistance and little degradation due to charging and discharging potentials. In addition, although the above materials have high ductility and are easily extended by a press, even when such a material is used, the to configuration of the present invention surely prevents winding slippage.

In the above configuration, when the cell capacities per unit area of the positive and negative electrode active material layers are respectively defined as A and B, the following formula may be satisfied: A≦B≦1.3 A.

In order to prevent precipitation of lithium at the negative electrode, it is preferred that the cell capacity per unit area of the negative electrode active material layer is set to be equal to or more than the cell capacity per unit area of the positive electrode active material layer. In addition, since the energy density is decreased when the cell capacity per unit area of the negative electrode active material layer is too large, it is preferred that the cell capacity per unit area of the negative electrode active material layer is equal to or less than 1.3 times the cell capacity per unit area of the positive electrode active material layer. It is more preferable to satisfy the following formula: 1.05 A≦B≦1.2 A.

In addition, an insulative negative electrode protective layer may be formed on the negative electrode active material layer. With the above configuration, the insulation between the positive and negative electrode active material layers is increased because of the insulative negative electrode protective layer, thus enhancing the safety in case of contamination of a conductive material in the cell. When a configuration is adopted in which the porosity of the negative electrode protective layer is larger than that of the negative electrode active material layer, it is possible to enhance non-aqueous electrolyte retention and permeability of the non-aqueous electrolyte into the negative electrode, and this allows shortening liquid injection time and improving cell characteristics such as cycle characteristics and load characteristics.

In addition, the negative electrode protective layer may be also provided on the negative electrode core exposed portion continuous to the negative electrode active material layer.

Preferably, the negative electrode protective layer consists of insulative inorganic particles and a binder. As the insulative inorganic particles, there can be used metal oxide particles such as zirconia, alumina, and titania. As the binder, an acrylonitrile-based binder, a fluorine-based binder and the like can be used.

Preferably, the present invention is used for a high capacity cell having cell capacity of 22 Ah or higher.

Herein, the cell capacity means discharge capacity (initial capacity) measured in the third step of the following steps:

The cell is charged at a constant current of 1 It to a voltage of 4.1 V, then charged at a constant voltage of 4.1 V for 2.5 hours, and then discharged at a constant current of 1 It to a voltage of 2.5 V. The charging and discharging are all performed at 25° C. In addition, the value of lit is a value of electric current that allows the cell capacity to be discharged in one hour.

In the above configuration, the positive electrode active material may be composed of lithium transition metal composite oxides while a negative electrode active material may be composed of carbonaceous materials.

It is preferable to use, as a positive electrode active material, lithium to transition metal composite oxides that have excellent discharge characteristics. For example, the positive electrode active material includes lithium-containing nickel cobalt manganese complex oxide (LiNiₓCo_{y}Mn_{z}O₂, x+y+z=1, 0≦x≦1, 0≦y≦1, 0≦z≦1), lithium manganese oxide (LiMn₂O₄), olivine-type lithium iron phosphate (LiFePO₄), and compounds obtained by substituting a part of transition metals contained in the above oxides with other elements. These compounds can be used alone or in a mixture of two or more.

Meanwhile, it is preferable to use carbonaceous materials having high capacity as a negative electrode active material. For example, the negative electrode active material includes carbonaceous materials such as natural graphite, carbon black, coke, glassy carbon, carbon fiber and calcined materials thereof.

### BRIEF DESCRIPTION OF THE DRAWING

FIG. 1 is a perspective view of a non-aqueous electrolyte secondary cell according to the present invention.

FIG. 2 is a diagram showing an electrode assembly used in the non-aqueous electrolyte secondary cell according to the present invention.

FIG. 3 is a plan view showing electrode plates used in the non-aqueous electrolyte secondary cell according to the present invention.

FIG. 3A shows a positive electrode, and FIG. 3B shows a negative electrode.

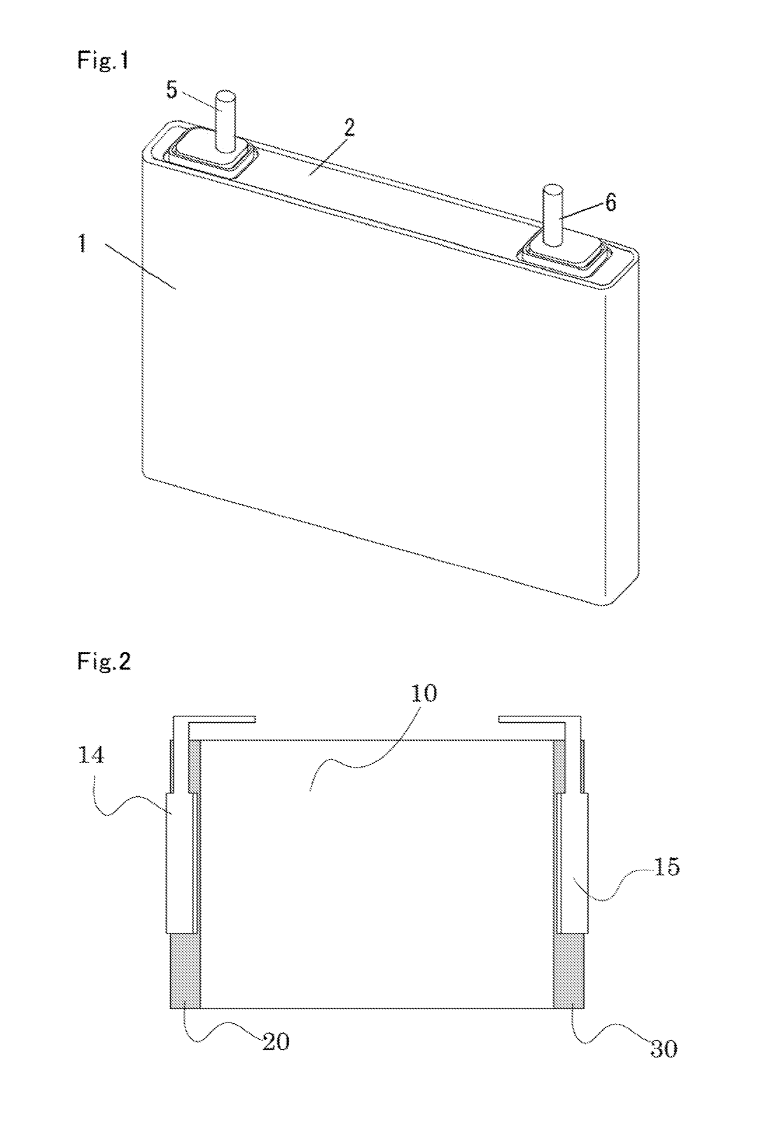

### DETAILED DESCRIPTION OF THE INVENTION

### Embodiment

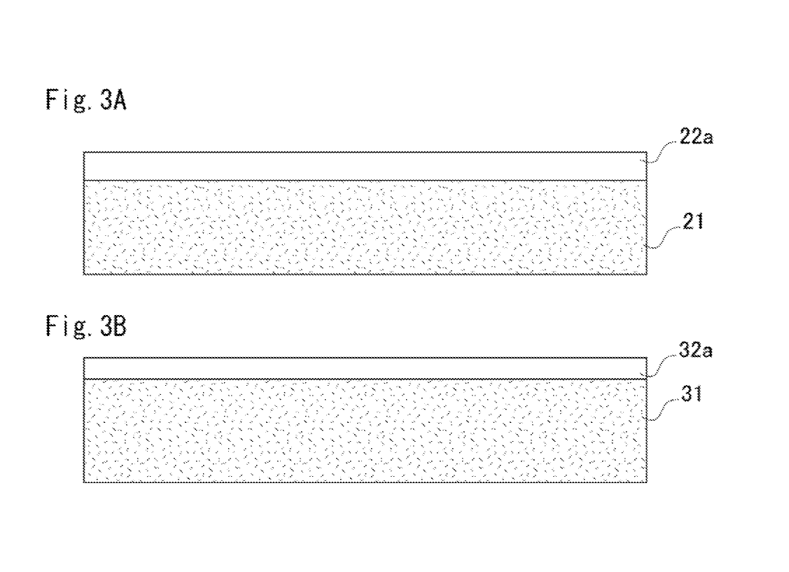

The present invention will be described below with reference to the drawings. FIG. l is a perspective view showing a non-aqueous electrolyte secondary cell according to the present invention. FIG. 2 is a diagram showing an electrode assembly used in the non-aqueous electrolyte secondary cell according to the present invention. And FIG. 3 is a plan view showing electrode plates used in the non-aqueous electrolyte secondary cell according to the present invention. FIG. 3A shows a positive electrode, and FIG. 3B shows a negative electrode.

As shown in FIG. l, the non-aqueous electrolyte secondary cell according to this Embodiment comprises a prismatic outer can 1 having an opening, a sealing body 2 for sealing the opening of the outer can 1, and positive and negative electrode external terminals 5 and 6 protruding outwardly from the sealing body 2.

In addition, as shown in FIG. 3A, the positive electrode plate constituting the electrode assembly comprises: a positive electrode core exposed portion 22a formed by exposing at least one side edge of a belt-shaped positive electrode core along the longitudinal direction of the positive electrode core; and a positive electrode active material layer 21 formed on positive electrode core. Meanwhile, as shown in FIG. 3B, the negative electrode plate comprises: a negative electrode core exposed portion 32a formed by exposing at least one side edge of a belt-shaped negative electrode core along the longitudinal direction of the negative electrode core; and a negative electrode active material layer 31 formed on the negative electrode core.

The electrode assembly 10 is formed by winding the positive electrode 20 and negative electrode 30 via a separator (not shown) consisting of a microporous membrane made of polyethylene. As shown in FIG. 2, the positive electrode core exposed portion, on which the active material layer of the positive electrode 20 is not formed, protrudes from one end of the electrode assembly 10 while the negative electrode core exposed portion, on which the active material layer of the negative electrode 30 is not formed, protrudes from the other end of the electrode assembly 10. The positive electrode current collector plate 14 is attached to the positive electrode core exposed portion while the negative electrode current collector plate 15 is attached to the negative electrode core exposed portion.

This electrode assembly 10 is housed in the above outer can together with the non-aqueous electrolyte. The positive electrode current collector plate 14 and negative electrode current collector plate 15 are electrically connected to external terminals 5 and 6 protruding and insulated from the sealing body 2, respectively. Thereby, electrical current is brought to the outside.

On the negative electrode active material layer, there can be provided a protective layer comprising insulative inorganic particles and a binder. It is preferable that the thickness of the protective layer is 1 to 10 and the porosity of the protective layer is 60 to 90%. And it is also preferable that the average particle diameter of the insulative inorganic particles is 0.1 to 10 μm. In addition, the insulative inorganic particles are to preferably at least one selected from the group consisting of alumina particles, titania particles and zirconia particles.

Hereinafter, the present invention is specifically explained using Examples. However, the present invention is not intended to be limited to these Examples, and the conditions such as used materials and mixing ratios may be suitably varied.

### EXAMPLE 1

<Preparation of Positive electrode>

A positive electrode active material of lithium-containing nickel cobalt manganese oxide (LiNi_{0.35}Co_{0.35}Mn_{0.3}O₂), a carbonaceous conductive agent such as acetylene black and graphite, and a binder of polyvinylidene fluoride (PVDF) were weighed at a mass ratio of 88:9:3. Then, these were dissolved in an organic solvent such as N-methyl-2-pyrrolidone (NMP) and mixed to prepare a positive electrode active material slurry.

Then, using a die coater or doctor blade, etc., the positive electrode active material slurry was applied in a uniform thickness on both surfaces of the positive electrode core composed of a belt-shaped aluminum foil (thickness: 15 μm). However, the slurry was not applied on one side edge (the same side in both surfaces) of the positive electrode core along the longitudinal direction in order to partly expose the positive electrode core, thereby forming a positive electrode core exposed portion.

This electrode plate was passed through a dryer to remove the organic solvent and to prepare a dry electrode plate. This dry electrode plate was pressed using a roll press machine to prepare a positive electrode plate. Then, the resulting plate is cut into a predetermined size to prepare a positive electrode.

The filling density of the positive electrode active material layer in the resulting positive electrode is 2.50 g/cc, and the thickness of the resulting positive electrode is 146 μm.

<Preparation of Negative electrode>

A negative electrode active material of graphite, a binder of a styrene-butadiene rubber, and a thickening agent of carboxymethylcellulose were weighed in a mass ratio of 98:1:1. Then, these were mixed with an appropriate amount of water to prepare a negative electrode active material slurry.

Then, using a die coater or doctor blade, etc., the negative electrode active material slurry was applied in a uniform thickness on both surfaces of the negative electrode core composed of a belt-shaped copper foil (thickness: 10 μm). However, the slurry was not applied on one side edge (the same side in both surfaces) of the negative electrode core along the longitudinal direction in order to partly expose the negative electrode core, thereby forming a negative electrode core exposed portion.

This electrode plate was passed through a dryer to remove water to produce a dry electrode plate. Then, this dry electrode plate was pressed using a roll press machine to prepare a negative electrode plate. The resulting plate was cut into a predetermined size to obtain a negative electrode.

The filling density of the negative electrode active material layer in the resulting negative electrode is 1.33 g/cc, and the thickness of the resulting negative electrode is 124 μm. In addition, the cell capacity per unit area of the negative electrode active material layer was set to 1.15 times the cell capacity per unit area of the positive electrode active material layer.

<Properties of Separator used >

There was used a separator having the thickness of 30 μm and the air permeability of 350 sec./100 cc measured in accordance with JIS P 8117:1998 (the air permeability per unit thickness of the separator: 11.7 sec/100 cc•μm). In this cell, the thickness ratio of separator/positive electrode is 20.5%, and the thickness ratio of separator/negative electrode is 24.2%.

<Preparation of Electrode assembly>

The three members (the above positive electrode, the above negative electrode and the above separator) were positioned and overlapped so that:
a plurality of the core expose portions of the same electrode might be directly overlapped;
the positive electrode core and the negative electrode core might protrude in directions counter to each other relative to the winding direction; and
the separator might be interposed between the different active material layers.

The three laminated members were wound using a winder, and an insulative winding-end tape was stuck thereon. Then, the resulting wound body was pressed to complete a flat electrode assembly.

<Connection of Current collector plate to Sealing body>

There were prepared one positive electrode current collector plate 14 made of aluminum and one negative electrode current collector plate 15 made of copper, on each of which two convex portions (not shown) protruding to one plane side are formed. Moreover, there were prepared two positive electrode current collector plate receiving members (not shown) made of aluminum and two negative electrode current collector plate receiving members (not shown) made of copper, on each of which one convex portion protruding to one plane side is formed. Then, an insulative tape was stuck so as to surround the convex portions of the positive electrode current collector plate 14, the negative electrode current collector plate 15, the positive electrode current collector plate receiving member and the negative electrode current collector plate receiving member.

A gasket (not shown) was arranged inside of a through hole (not shown) formed in the sealing body 2, and arranged on the outer surface of the cell surrounding the through hole. Meanwhile, an insulating member (not shown) was arranged on the inner surface of the cell surrounding the through hole in the sealing body 2. And the positive electrode current collector plate 14 was positioned on the insulating member provided on the cell inner surface of the sealing body 2 so as to overlap the through hole of the sealing body 2 with the through hole (not shown) provided in the current collector plate. Then, an insertion portion of the positive electrode external terminal 5 having a flange area (not shown) and an insertion area (not shown) was passed through the through holes of the sealing body 2 and the current collector plate from the outside of the cell. While this structure was kept, the diameter of the lower part (cell inner part) of the insertion portion was increased, and the positive electrode external terminal 5 was caulked to the sealing body 2 together with the positive electrode current collector plate 14.

The same manner was also applied to the negative electrode. The negative electrode external terminal 6 was caulked to the sealing body 2 together with the negative electrode current collector plate 15. This process allows each member to be integrated, and the positive and negative electrode current collector plates 14 and 15 are conductively connected to the positive and negative electrode external terminals 5 and 6, respectively.

And the positive and negative electrode external terminals 5 and 6 protrude from the sealing body 2 with them insulated from the sealing body 2.

<Attachment of Current collector plates>

Onto one surface of the core exposed portion in the positive electrode 20 of the flat electrode assembly, the positive electrode current collector plate 14 was applied with its convex portions on the side of the positive electrode core exposed portion. Then, one of the positive electrode current collector plate receiving members is applied onto the positive electrode core exposed portion in such a manner that the convex portion thereof would come into contact with the positive electrode core exposed portion and that one of the convex portions of the positive electrode current collector plate 14 and the convex portion of the positive electrode current collector plate receiving member would oppose to one another. Thereafter, a pair of welding electrodes were applied on the back of the convex portion of the positive electrode current collector plate 14 and the back of the convex portion of the positive electrode current collector plate receiving member. Electric current is flowed to the welding electrodes for a resistance welding of the positive electrode current collector plate 14 and the positive electrode current collector plate receiving member to the positive electrode core exposed portion.

Then, the other positive electrode current collector plate receiving members is applied onto the positive electrode core exposed portion in such a manner that the convex portion thereof would come into contact with the positive electrode core exposed portion and that the other convex portion of the positive electrode current collector plate 14 and the convex portion of the positive electrode current collector plate receiving member would oppose to one another. Thereafter, a pair of welding electrodes are applied on the back of the convex portion of the positive electrode current collector plate 14 and the back of the convex portion of the positive electrode current collector plate receiving member. Electric current was flowed to the welding electrodes for a second resistance welding. Through the above process, the positive electrode current collector plate 14 and positive electrode current collector plate receiving member were fixed to the positive electrode core exposed portion.

The same manner was also applied to the negative electrode 30. The negative electrode current collector plate 15 and the negative electrode current collector plate receiving member were resistance welded.

<Preparation of a non-aqueous electrolyte>

LiPF₆ as an electrolyte salt was dissolved at 1.0M (mol/l) into non-aqueous solvent in which ethylene carbonate (EC) and ethyl methyl carbonate (EMC) were mixed in the ratio of 3:7 (volume ratio converted at 1 atm (101325 Pa) and 25 ° C.), thus forming a base electrolyte solution. Then, 0.3% by mass of vinylene carbonate, 0.1 M of lithium bis(oxalate)borate and 0.05 M of lithium difluorophosphate were added to the above base electrolyte solution to complete a non-aqueous electrolyte.

### <Fabrication of Cell>

The electrode assembly 10 integrated with the sealing body 2 was inserted in an outer can 1, and the opening of the outer can 1 is fitted to the sealing body 2. Then, the joint of the outer can 1 and the periphery of the sealing body 2 were laser welded. After injecting a predetermined amount of the above-mentioned non-aqueous electrolyte into a non-aqueous electrolyte injection hole (not shown) provided on the sealing body 2, this non-aqueous electrolyte injection hole was sealed to complete a non-aqueous electrolyte secondary cell according to Example 1.

### EXAMPLE 2

A non-aqueous electrolyte secondary cell according to Example 2 was fabricated in the same manner as above-described Example 1 except that the filling density of the positive electrode active material layer was 2.54 g/cc, the thickness of the positive electrode was 151 μm, the filling density of the negative electrode active material layer was 1.36 g/cc, the thickness of the negative electrode was 128 μm, the thickness of the separator was 25 μm, and the air permeability per unit thickness of the separator was 14.0 sec/(100 cc•μm). In this cell, the thickness ratio of separator/positive electrode is 16.6%, and the thickness ratio of separator/negative electrode is 19.5%.

### COMPARATIVE EXAMPLE 1

A non-aqueous electrolyte secondary cell according to Comparative Example 1 was fabricated in the same manner as above-described Embodiment except that the filling density of the positive electrode active material layer was 2.90 g/cc, the thickness of the positive electrode was 128 μm, the filling density of the negative electrode active material layer was 1.33 g/cc, the thickness of the negative electrode was 124 μm, the thickness of the separator was 30 μm, and the air permeability per unit thickness of the separator was 11.7 sec./(100 cc•μm). In this cell, the thickness ratio of separator/positive electrode is 23.4%, and the thickness ratio of separator/negative electrode is 24.2%.

### COMPARATIVE EXAMPLE 2

A non-aqueous electrolyte secondary cell according to Comparative Example 2 was fabricated in the same manner as above-described Embodiment except that the filling density of the positive electrode active material layer was 1.98 g/cc, the thickness of the positive electrode was 180 μm, the filling density of the negative electrode active material layer was 1.33 g/cc, the thickness of the negative electrode was 124 μm, the thickness of the separator was 30 μm, and the air permeability per unit thickness of the separator was 11.7 sec./(100 cc•μm). In this cell, the thickness ratio of separator/positive electrode is 16.7%, and the thickness ratio of separator/negative electrode is 24.2%.

### COMPARATIVE EXAMPLE 3

A non-aqueous electrolyte secondary cell according to Comparative Example 3 was fabricated in the same manner as above-described Embodiment except that the filling density of the positive electrode active material layer was 2.50 g/cc, the thickness of the positive electrode was 146 μm, the filling density of the negative electrode active material layer was 1.60 g/cc, the thickness of the negative electrode was 101 μm, the thickness of the separator was 30 μm, and the air permeability per unit thickness of the separator was 11.7 sec/(100 cc•μm). In this cell, the thickness ratio of separator/positive electrode is 20.5%, and the thickness ratio of separator/negative electrode is 28.6%.

### COMPARATIVE EXAMPLE 4

A non-aqueous electrolyte secondary cell according to Comparative Example 4 was fabricated in the same manner as above-described

Embodiment except that the filling density of the positive electrode active material layer was 2.50 g/cc, the thickness of the positive electrode was 146 μm, the filling density of the negative electrode active material layer was 0.97 g/cc, the thickness of the negative electrode was 160 μm, the thickness of the separator was 30 μm, and the air permeability per unit thickness of the separator was 11.7 sec/(100 cc•μm). In this cell, the thickness ratio of separator/positive electrode is 20.5%, and the thickness ratio of separator/negative electrode is 18.8%.

### COMPARATIVE EXAMPLE 5

A non-aqueous electrolyte secondary cell according to Comparative Example 5 was fabricated in the same manner as above-described Embodiment except that the filling density of the positive electrode active material layer was 2.50 g/cc, the thickness of the positive electrode was 146 μm, the filling density of the negative electrode active material layer was 1.33 g/cc, the thickness of the negative electrode was 124 μm, the thickness of the separator was 41 μm, and the air permeability per unit thickness of the separator was 11.7 sec/(100cc•μm). In this cell, the thickness ratio of separator/positive electrode is 27.8%, and the thickness ratio of separator/negative electrode is 33.3%.

In the above Examples and Comparative Examples, the parameters were adjusted as follows: the thickness and filling density was adjusted by varying the coating amount of the active material slurry and the roll pressure. In addition, the filling amounts of the positive and negative electrode active materials were identical in all of the above-described Examples and Comparative Examples.

(Determination of Winding slippage)

One hundred samples were prepared per each electrode assembly of the cells according to Examples 1 and 2 and Comparative Examples 1 to 5, and the occurrence of winding slippage was determined based on the position of the edge of the electrode plate detected by laser beam. As a result, winding slippage was found in Comparative Example 1 and 3 while it was not found in Examples 1 and 2, and Comparative Example 2, 4 and 5.

### (Insertion Test)

Each of the above electrode assemblies of Examples 1 and 2 and Comparative Example 2, 4 and 5, in all of which the winding slippage was not found, was inserted into an outer can having 146.6 mm width, 25.1 mm thickness and 89.5 mm height (all of which were internal dimensions.) At this time, electrode assembly insertion was determined as bad when the thickness of the electrode assembly was equal to or more than that of the outer can, while electrode assembly insertion was determined as good when the thickness of the electrode assembly was less than that of the outer can. As a result, regarding the electrode assembly insertion, Comparative Example 2, 4 and 5 were determined as bad while Examples 1 and 2 were determined as good.

(Nail penetration test)

There were produced 100 samples per each of the cells according to Examples 1 and 2 which show no winding slippage and good results in the insertion test. These cells were charged at a constant current of 1 It (25 A) to a voltage of 4.1 V, and then charged at a constant voltage of 4.1 V for 2 hours. Thereafter, a nail with 3 mm diameter and 5.5 cm length was penetrated in the center of the cell at a penetration rate of 80 mm/sec, and occurrence of explosion or ignition of the cell was checked. As a result, no explosion or ignition was found.

The reasons for these results are considered as follows. When the filling density of the positive or negative electrode active material layer is too high, the core tends to be elongated due to rolling for high density, and thereby winding slippage easily occurs. For this reason, winding slippage is found in Comparative Example 1, in which the filling density of the positive electrode active material layer is 2.90 g/cc, and in Comparative Example 3, in which the filling density of the negative electrode is 1.60 g/cc.

Meanwhile, when the filling density of the positive or negative electrode active material layer is too low, the volume energy density becomes smaller. If the cell capacity is made identical in this situation, the volume of the electrode assembly becomes too large, thus leading to the problem with the electrode assembly insertion. The same is true of the case in which the thickness of the separator is too large. For this reason, it is found that there was the problem with the electrode assembly insertion in Comparative Example 2 (the filling density of the positive electrode active material layer is 1.98 g/cc.), Comparative Example 4 (the filling density of the negative electrode active material layer is 0.97 g/cc.), and Comparative Example 5 (the thickness of the separator is 33.3% of that of the negative electrode.).

In contrast, the above problems are not seen in Examples 1 and 2 satisfying the following requirements:
the filling density of the positive electrode active material layer is 2.0 to 2.8 g/cc
the filling density of the negative electrode active material layer is 1.0 to 1.5 g/cc
the thickness of the positive electrode plate is 100 to 200 μm;
the thickness of the negative electrode plate is 100 to 200 μm;
the thickness of the separator is 10 to 30% of the thickness of the positive electrode plate and is 10 to 30% of the thickness of the negative electrode plate;

the air permeability per unit thickness of the separator is 7.0 to 27.0 sec/100 cc•μm.

Specifically, in Examples 1 and 2, winding slippage was prevented, and there was no problem with the electrode assembly insertion. Moreover, the positive and negative electrodes are surely insulated by a separator, and a large current does not flow at the time of forced short circuit such as nail penetration. Therefore, no explosion or ignition is found in the nail penetration test.

### (Supplementary Remarks)

The positive electrode active material include, for example, lithium-containing transition metal composite oxides such as lithium-containing nickel cobalt manganese complex oxide (LiNiₓCo_{y}Mn_{z}O₂, x+y+z=1, 0≦x≦1, 0≦y≦1, 0≦z≦1), lithium manganese oxide (LiMn₂O₄), olivine-type lithium iron phosphate (LiFePO₄), and compounds obtained by substituting a part of transition metals contained in the above oxides with other elements. These compounds can be used alone or in a mixture of two or more.

In addition, the negative electrode active material includes carbonaceous materials such as natural graphite, carbon black, coke, glassy carbon, carbon fiber and calcined materials thereof.

As the non-aqueous solvent, there can be used a mixture of a low viscosity solvent and a high dielectric solvent having high solubility of lithium salts. The high dielectric solvent includes, for example, ethylene carbonate, propylene carbonate, butylene carbonate, and γ-butyrolactone. The low viscosity solvent includes diethyl carbonate, dimethyl carbonate, ethyl methyl carbonate, 1,2-dimethoxy-ethane, tetrahydrofuran, anisole, 1,4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, ethyl propionate. Also, the non-aqueous solvent may be a mixture of two or more kinds of the above-listed high dielectric solvents and two or more kinds of the above-listed low viscosity solvents. Besides LiPF₆ used in the Embodiment, the electrolyte salts include LiN(C₂F₅SO₂)₂, LiN(CF₃SO₂)₂, LiClO₄ and LiBF₄, all of which can be used alone or in combination of two or more. Moreover, lithium bis(oxalate)borate, lithium difluorophosphate and the like can be also added to the above lithium salts. The total concentration of lithium salt in the non-aqueous electrolyte is preferably 0.5 to 2 M(mol/l).

Known additives such as vinylene carbonate, cyclohexyl benzene and tert-amylbenzene can be also added to the non-aqueous electrolyte.

As the separator, there can be used a microporous film composed of olefin resins such as polyethylene, polypropylene and a mixture or laminate thereof.

The method for preparing the insulative negative electrode protective layer includes, for example, a method explained below.

Alumina powder as insulative inorganic particles, an acrylonitrile-based binder and NMP are mixed in a mass ratio of 30:0.9:69.1 to prepare a slurry, and this slurry is applied on a negative electrode active material layer of the dried negative electrode plate after rolling process. The resulting electrode plate is dried again, and NMP required for the slurry preparation was evaporated and removed to prepare a negative electrode having the negative electrode protective layer. As explained above, the present invention can provide a non-aqueous electrolyte secondary cell having excellent safety and high capacity. Thus, the industrial applicability is significant.

What is claimed is:

1. A non-aqueous electrolyte secondary cell comprising a wound electrode assembly,
wherein:
the wound electrode assembly is formed by winding a positive electrode plate, a negative electrode plate and a separator separating the positive and negative electrode plates;
the positive electrode plate has a positive electrode core exposed portion, which is formed by exposing at least one side edge of a belt-shaped positive electrode core along the longitudinal direction of the positive electrode core, and a positive electrode active material layer formed on the positive electrode core;
the negative electrode plate has a negative electrode core exposed portion, which is formed by exposing at least one side edge of a belt-shaped negative electrode core is exposed along the longitudinal direction of the negative electrode core, and a negative electrode active material layer formed on the negative electrode core;
the filling density of the positive electrode active material layer is 2.0 to 2.8 g/cc;
the filling density of the negative electrode active material layer is 1.0 to 1.5 g/cc;
the thickness of the positive electrode plate is 100 to 200 μm;
the thickness of the negative electrode plate is 100 to 200 μm;
the thickness of the separator is 10 to 30% of each thickness of the positive and negative electrode plates; and
the air permeability per unit thickness of the separator is 7.0 to 27.0 sec/100 cc•μm.

2. The non-aqueous electrolyte secondary cell according to claim 1, wherein the positive electrode core is made of pure aluminium or aluminium alloy, and the negative electrode core is ma de of pure copper or copper alloy.

3. The non-aqueous electrolyte secondary cell according to claim 1, wherein when the cell capacities per unit area of the positive and negative electrode active material layers are respectively defined as A and B, the following formula is satisfied: A≦B≦1.3 A.

4. The non-aqueous electrolyte secondary cell according to claim 1, wherein an insulative negative electrode protective layer is formed on the negative electrode active material layer.

5. The non-aqueous electrolyte secondary cell according to claim 1, wherein the cell capacity of the non-aqueous electrolyte secondary cell is 22 Ah or more.

6. The non-aqueous electrolyte secondary cell according to claim 1, wherein the positive electrode active material is composed of a lithium transition metal composite oxide, and the negative electrode active material is composed of a carbonaceous material.

7. The non-aqueous electrolyte secondary cell according to claim 4, wherein the porosity of the negative electrode protective layer is larger than the porosity of the negative electrode active material layer.

8. The non-aqueous electrolyte secondary cell according to claim 4, wherein the porosity of the negative electrode protective layer is 60 to 90%.

9. The non-aqueous electrolyte secondary cell according to claim 4, wherein the negative electrode protective layer consists of insulative inorganic particles and a binder.

10. The non-aqueous electrolyte secondary cell according to claim 9, wherein the average particle diameter of the insulative inorganic particles is 0.1 to 10 μm.

11. The non-aqueous electrolyte secondary cell according to claim 9, wherein the insulative inorganic particles are at least one selected from the group consisting of alumina particles, titania particles and zirconia particles.
